(19) United States
(12) Patent Application Publication
(10) Pub. No.: US 2002/0007296 A1
(43) Pub. Date: Jan. 17, 2002

(54) System for providing information relating to dream

(76) Inventors: Mari Yajima, Kawasaki (JP); Yasuhiro Hirano, Kawasaki (JP); Takeshi Tomomatsu, Kawasaki (JP); Chiaki Yamauchi, Shinagawa (JP); Yumi Kuroda, Shinagawa (JP); Hiroyuki Takigawa, Kawasaki (JP)

Correspondence Address: STAAS & HALSEY, Suite 500, 700 Eleventh Street, N.W., Washington, DC, 20001, US

(21) Appl. No.: 09/747,965

(22) Filed: Dec. 27, 2000

(30) Foreign Application Priority Data
Jul. 17, 2000 (JP) 2000-216379

(51) Int. Cl. G06F 17/60

(52) U.S. Cl. 705/8

(57) ABSTRACT

The object of the present invention is to provide a technique for furnishing a total information service that can assist a user to achieve a dream. A computer system of the present invention reads out, from a data storage device, client specification information respectively specifying one client and other clients who belong to a genre registered by the one client in advance if client identification information is received from a terminal of the one client. Then, the computer system transmits to the terminal of the one client, display information wherein each of the read client specification information is positioned at a predetermined location. Thus, the client can easily ascertain that there are other participants who share the same dream, and from this, can acquire a sense of comradeship with other participants and a strengthened determination to achieve his or her object. Furthermore, this can provide motivation for communication with other participants. In addition, even if the client does not remember his or her registered genre, the client can automatically obtain display information relative to the genre registered by the client from the computer system of the present invention. Therefore, usability is enhanced by the present invention.

### TECHNICAL FIELD OF THE INVENTION

The present invention relates to a technique for providing information via a network, such as the Internet, and more particularly to a technique for providing both information that is related to an entry registered by a registered member and a site for facilitating communication with other members.

### BACKGROUND OF THE INVENTION

The Internet has grown dramatically in recent years, and a huge number and variety of homepages have been created. Because of the enormous amount of information that has thus been made available, a lot of people frequently come up with difficulty to obtain an objective URL (Uniform Resource Locator) of a web site on the Internet that provides desired information. If, for example, the objective information concerns something like, “my dream”, the task of finding appropriate information becomes even more difficult.

Also, although many web sites carry advertisements, and although many means have been devised for the dispersal of advertisements, so many unnecessary advertisements are still distributed on the Internet. On the other hand, it is difficult to find an advertisement related to, for example, “my dream” as the need arises. It is also difficult to find web sites about experts in specific fields, and there is little chance that a user will be able to receive comments or advice directly from experts or from persons having the same object.

As described above, conventionally, no total service is available that provides information for the accomplishment of a specific object, or a dream, and/or a site for facilitating communication with other persons having the same object and/or having expertise in a specific field.

### SUMMARY OF THE INVENTION

It is, therefore, one object of the present invention to provide a technique for furnishing a total information service that enables a user to aggressively pursue and fulfill own dream.

It is another object of the present invention to provide a technique that enables clients who share a specific object to communicate with each other.

It is an additional object of the present invention to provide a technique for providing useful information that relates to an attribute, such as a specific object, of a client.

It is a further object of the present invention to provide a technique for enabling a client to communicate with an expert concerning an attribute, such as a specific object.

According to the present invention, a computer system reads out, from a data storage device, client specification information (e.g., image information for a votive panel that is registered by each client) respectively specifying one client and other clients (or other participants) who belong to a genre (e.g., a “dream” genre) registered by the one client in advance if client identification information (e.g., the member ID) is received from a terminal (e.g., a member) of the one client. Then, the computer system transmits to the terminal of the one client, display information (e.g., information of a tree web page (FIG. 1)) wherein each of the read client specification information is positioned at a predetermined location. Thus, the client can easily ascertain that there are other participants who share the same dream, and from this, can acquire a sense of comradeship with other participants and a strengthened determination to achieve his or her object. Furthermore, this can provide motivation for communication with other participants. In addition, even if the client does not remember his or her registered genre, the client can automatically obtain display information relative to the genre registered by the client from the computer system of the present invention. Therefore, usability is enhanced by the present invention.

The computer system may further retrieve, from a data storage device, information, that matches an attribute registered in advance, of a selected client corresponding to a selected client specification information if information concerning a selection of client specification information is received from the terminal of the one client, and forms display information (e.g., information for a votive panel web page (FIG. 2)) for the selected client. Then, the computer system may further transmit, to the terminal of the one client, the formed display information. With this configuration, the user can read not only his own homepage but also the homepages of others. Since information that matches the attribute is displayed, there is no possibility that an unnecessary advertisement will be presented.

In addition, the computer system may further comprise means for registering comments for each client by other clients and form display information for the client that includes the comments registered by other clients. With this configuration, communication between clients can be facilitated.

The computer system may further comprise means for registering comments from an expert in a genre that has been registered by the client in advance, and form display information for the client which includes the comments from the expert. With this configuration, advice provided by the expert can be obtained.

### BRIEF DESCRIPTION OF THE DRAWINGS

FIG. 1 is a diagram showing an example tree web page;

FIG. 2 is a diagram showing an example votive panel web page;

FIG. 3 is a diagram showing a comment input screen;

FIG. 4 is a diagram of an example public homepage for an expert;

FIG. 5 is a diagram showing an overview of a system according to the preferred embodiment of the present invention;

FIG. 6 is a diagram showing an example member information management table;

FIG. 7 is a diagram showing an example link destination management table for each genre;

FIG. 8 is a diagram showing an example display information management table;

FIG. 9 is a diagram showing an example votive panel shuffle management table;

FIG. 10 is a diagram showing an example screen if the arrangement of votive panel images in FIG. 1 has been changed;

FIG. 11 is a flowchart showing the member registration processing;

FIG. 12 is a diagram showing an example dream information input screen;

FIG. 13 is a diagram showing an example menu list for a genre box;

FIG. 14 is a flowchart showing the member information registration processing;

FIG. 15 is a diagram showing the processing performed if a member terminal accesses to a network votive panel server;

FIG. 16 is a flowchart showing the processing performed if a member selects his or her own votive panel in FIG. 1;

FIG. 17 is a flowchart showing the processing performed if a member selects a votive panel of another member in FIG. 1;

FIG. 18 is a flowchart showing the processing performed if a preceding tree button or a next tree button is selected on in FIG. 1;

FIG. 19 is a flowchart showing the processing performed if another genre is selected in a genre box in FIG. 1;

FIG. 20A and FIG. 20B is a flowchart showing the processing performed if an expert advice request button in FIG. 2 is depressed;

FIG. 21 is a diagram showing an example expert web page;

FIG. 22 is a diagram showing an example to indicate the expert web page;

FIG. 23 is a flowchart showing the processing performed if an add button in FIG. 2 is clicked on;

FIG. 24 is a flowchart showing the processing performed to shuffle votive panel images on a tree web page;

FIGS. 25A and 25B are diagrams showing how a votive panel shuffle management table is changed; and

FIG. 26 is a diagram showing the change of a tree HTML file.

### DETAIL DESCRIPTION OF THE PREFERRED EMBODIMENT

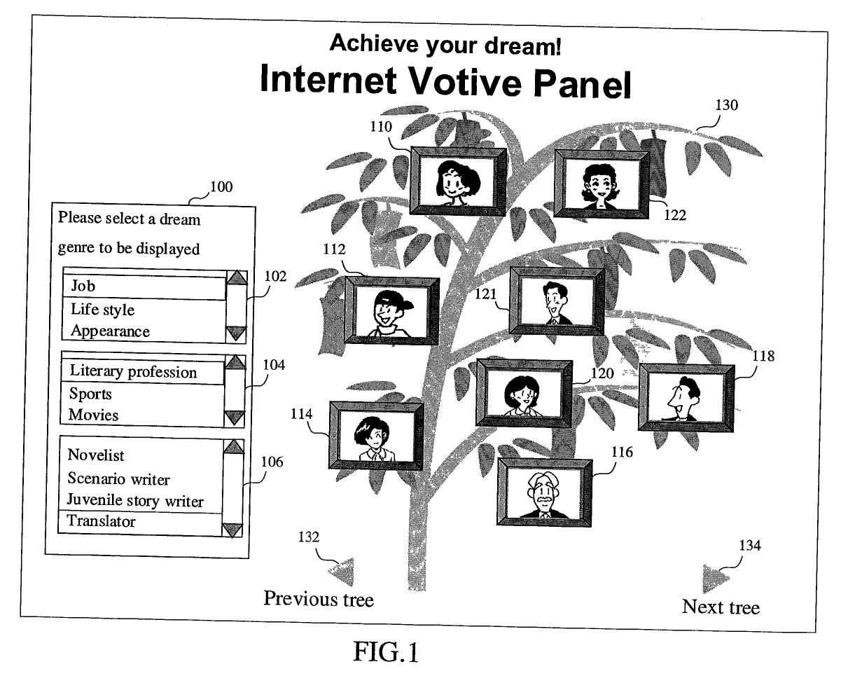

The overview of the preferred embodiment of the present invention will now be described while referring to FIGS. 1 to 4. A service related to this embodiment is a service for providing information concerning a “dream”. For example, a user can register his or her dream and can receive information related to the dream, and an advertisement for a product or a service associated with the dream. Then, the user can get in touch with clients (members) who share the same dream, and can receive advice from an expert whose field is associated with that of the dream. In this embodiment, the provision of a service that is governed by rules of membership is premised. Thus, a person who desires to participate as a member has to register in advance, and has to have received a member ID and a password. FIG. 1 is a diagram showing an example screen (hereinafter referred to as a tree web page) that is displayed on the terminal of a member after the ID and the password of that member has been verified.

In this example, an image of a tree 130 is displayed, and votive panels 110 to 122, for the member who has just logged in and for other members who have registered the same genre as that of the “dream” of the pertinent member, are hung from the tree 130. The images of the votive panels 110 to 122 are registered in advance by the respective members, and are reduced in size for the display. As shown FIG. 1, the images of votive panels include portraits. However, the portrait is only an example; any images can be employed so long as the respective members can be identified. The representation of the tree 130 can be changed seasonally. For example, for the weaver festival season the tree image can be changed to that of a bamboo, or in spring, an image of a cherry tree in full blossom can be used. Furthermore, links to the web sites for respective members are embedded in the image information of the votive panels 110 to 122.

A menu for the selection of the genre of a dream is provided in a genre box 100. For this embodiment, an upper level menu 102, a medium level menu 104 and a lower level menu 106 are available. If a member desires to refer to a genre other than the “dream” genre that he or she has registered, the member selects a desired genre in accordance with the order represented by the upper, the medium and lower level menus. Then, a screen (a tree web page) which includes a tree representing the selected genre and the votive panels are displayed on the terminal of the requesting member.

When, for a genre, a large number of members are registered, votive panels for all of the members can not be hung from one tree 130, i.e., can not all be displayed on the same screen. Therefore, in this embodiment, the number of votive panels to be hung from one tree 130 is limited to a predetermined number (eight in FIG. 1). When the number of registered members exceeds the predetermined number, another tree is formed and the votive panels of the remaining members are hung therefrom. Thus, if a plurality of trees are prepared for the same genre, an instruction to change from one tree to another is given by clicking on a previous tree button 132 or on a next tree button 134, positioned in among the tree branches (part other than votive panel) or at the bottom of the screen. Then, another screen (tree web page) is displayed in which the votive panels of different members are hung from a tree.

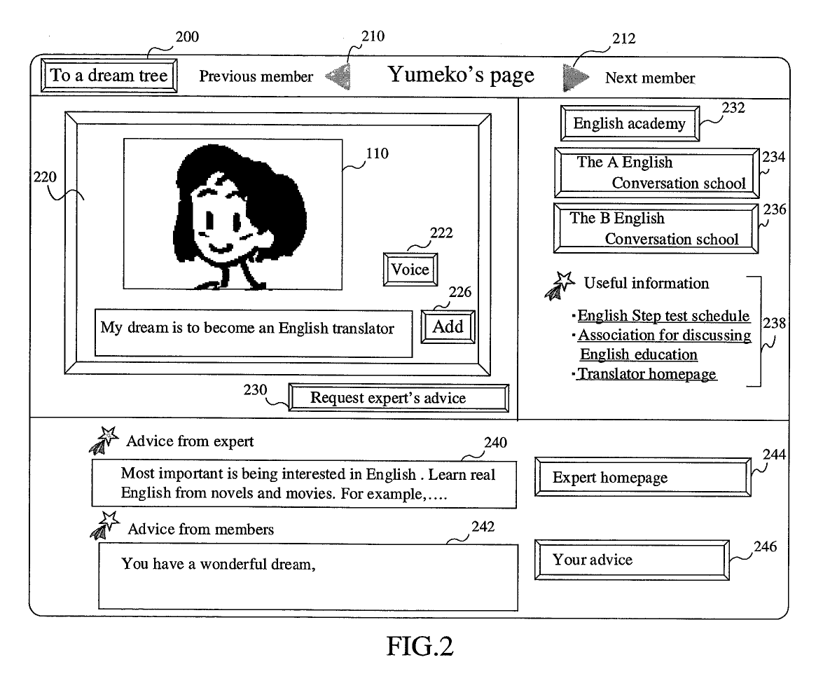

FIG. 2 is a diagram showing an example of a screen (hereinafter referred to as a votive panel web page) that is displayed if a member who logged in uses a mouse to click on the image of his or her own votive panel 110 for selection. On this screen, a votive panel area 220 is displayed that includes: a comment column 244 including comments concerning the dream, a button 222 for reproducing, if registered, a voice message; and an add button 226 for adding a comment etc. In addition, this screen includes: an expert advice request button 230, for displaying a screen on which a user enters an inquiry, or the details of a personal affair, if he or she seeks advice from an expert in a field related to his or her dream; an advice display column 240, for displaying the advice provided by the expert in response to the inquiry or the details of the personal affair, that was previously entered using the expert advice request button 230; and an advice or a comment display column 242, for displaying advice or comments received from another member. The experts associated with this embodiment each have a public homepage and a work homepage, and when a member depresses an expert home page button 244, the public homepage of the expert can be displayed.

In this embodiment, a member can also read the votive panel web page of a different member. That is, if the screen in FIG. 1 (tree web page) is displayed, and if the member selects the image of a desired votive panel by clicking on it, the votive panel web page of the selected member is displayed, regardless of who that web page belongs to. If, while reading the votive panel web page of another member, a member desires to enter advice or a comment therein, the member need only depress a “your advice” button 246 in FIG. 2. Then, an advice or comment input screen appears. When the member enters and registers his or her advice or comment, the entry will be displayed in the advice or comment display column 242.

A banner advertisement 232 for an “English academy”, a banner advertisement 234 for the “A English conversation school”, a banner advertisement 236 for the “B English conversation school”, and a column 238 which includes link destination information of the web page that can help the member achieve his or her dream are displayed on the right of the votive panel web page screen. When a member clicks on an interesting banner advertisement, the votive panel web page is shifted to the web site of the pertinent advertiser. The same procedure can be employed to switch to an interesting link destination.

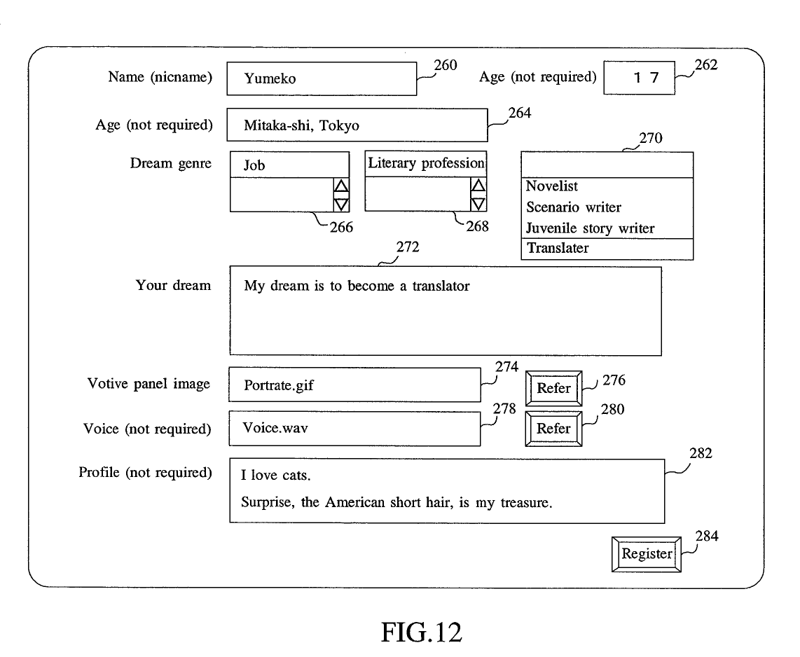

Also provided in the topmost panel of the votive panel web page are a “to dream tree” button 200, for returning to the tree web page in FIG. 12, and a previous member button 210 and a next member button 212, for shifting the screen to the votive panel web page of another member.

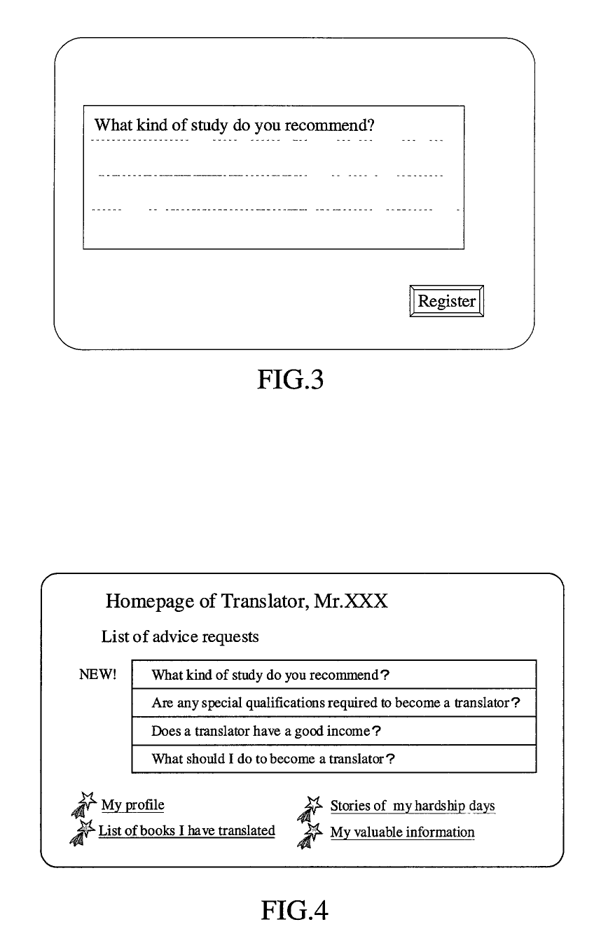

FIG. 3 is a diagram showing an example screen if the expert advice request button 230 in FIG. 2 is clicked on. As shown in FIG. 3, a comment input column 250 and a register button 252 are provided on the screen, and if the register button 252 is clicked on, the data entered in the comment input column 250 are registered. The screen shown in FIG. 3 also appears if the “your advice” button 246 is clicked on, and permits a member to enter advice.

FIG. 4 is a diagram showing the homepage of an expert that is displayed upon the depression of the expert homepage button 244 in FIG. 2. Provided on this homepage is an advice request list 260 of inquiries or requests for counseling that the expert has accepted. The respective items in the advice request list 260 are buttons, and if one of the items is clicked on, the homepage is shifted to the votive panel web page of the member who issued the inquiry or who requested the counseling. Information that the pertinent expert voluntarily provides, i.e., a link 262 to a “My profile” page, a link 266 to “Stories of my hardship days”, a link 264 to a “List of books I have translated”, a link 268 to “My valuable information” are provided below the advice request list 260.

By presenting these screens to members, information that matches the states or attributes of the members can be provided, communication among the members can be encouraged and further communication with the experts is also facilitated. Thus, an attractive communication environment for achieving the dream can be provided.

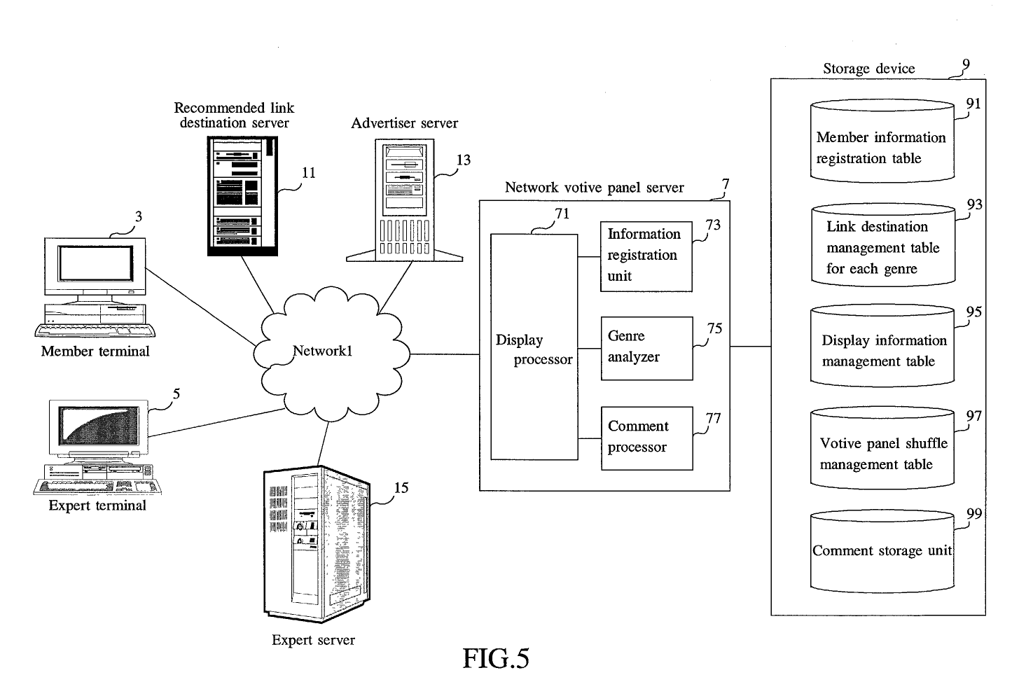

An overview of the system employed for the embodiment will now be described while referring to FIG. 5. One or more member terminals 3, one or more expert terminals 5, a network votive panel server 7, which mainly provides a service relating to the embodiment, one or more recommended link destination servers 11, which provide useful information for the achievement of a “dream”, one or more advertiser servers 13, which are run by banner advertisers, and an expert server 15, which provides expert information, are connected to a network 1, the Internet, for example. The network votive panel server 7, the recommended link destination server 11, the advertiser server 13, and the expert server 15 have a so-called web server function. The member terminal 3 and the expert terminal 5 may be so-called personal computers, and can execute a Web browser.

The network votive panel server 7 comprises a display processor 71, mainly for performing the web server function; an information registration unit 73, for performing a member registration process; a genre analyzer 75, for analyzing the genre of a “dream” that a new member registers at the time of the member registration, and for performing necessary processing; and a comment processor 77, for processing comments that an expert and/or a certain member enters when advising another member. Further, a member information registration table 91, a link destination management table 93 for each genre, a display information management table 95, a votive panel shuffle management table 97, and a comment storage unit 99 are prepared in a storage device 9 that is connected to the network votive panel server 7.

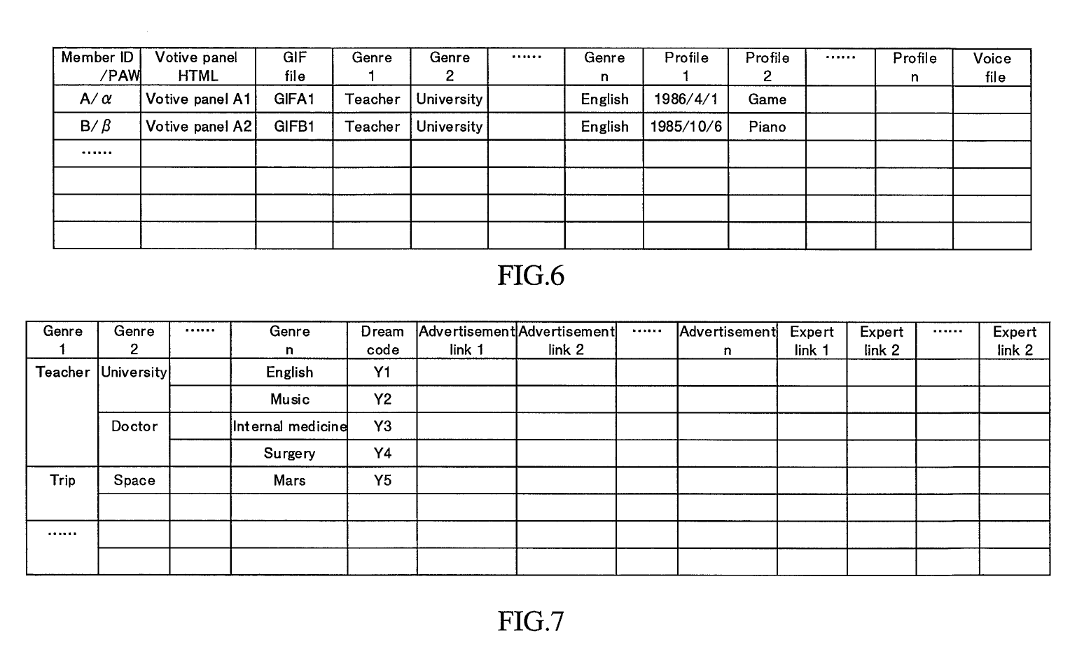

FIG. 6 is a diagram showing an example member information registration table 91. For each member, the member information registration table 91 includes a member ID/password (PW), the file name (or the storage location in the storage device 9) of a votive panel HTML file for a votive panel web page, the image file name (or the storage location in the storage device 9) of a votive panel image, an item name selected for each level (level 1 to n) of the “dream” genre, the profile information for a member (n profiles can be registered in this embodiment), and the voice file name (or the storage location in the storage device 9) of the member. Although in this embodiment a GIF type file is employed for the image file, a JPEG type image file may also be employed.

FIG. 7 is a diagram showing an example link destination management table 93 for each genre. This table 93 is a table representing a model for selecting information that should be provided for a member who has chosen a specific genre. A genre input by the member is specified by the genres 1 to n. Corresponding to the specified genre, a dream code, which is a code for a genre at the lowest level, advertisement links 1 to n, expert links 1 to n, and useful information links (not shown) are stored. In the member registration process, information, including advertisement links and etc. that corresponds to the specified genre (dream code), is copied and entered in the information column of the pertinent member in the display information management table 95.

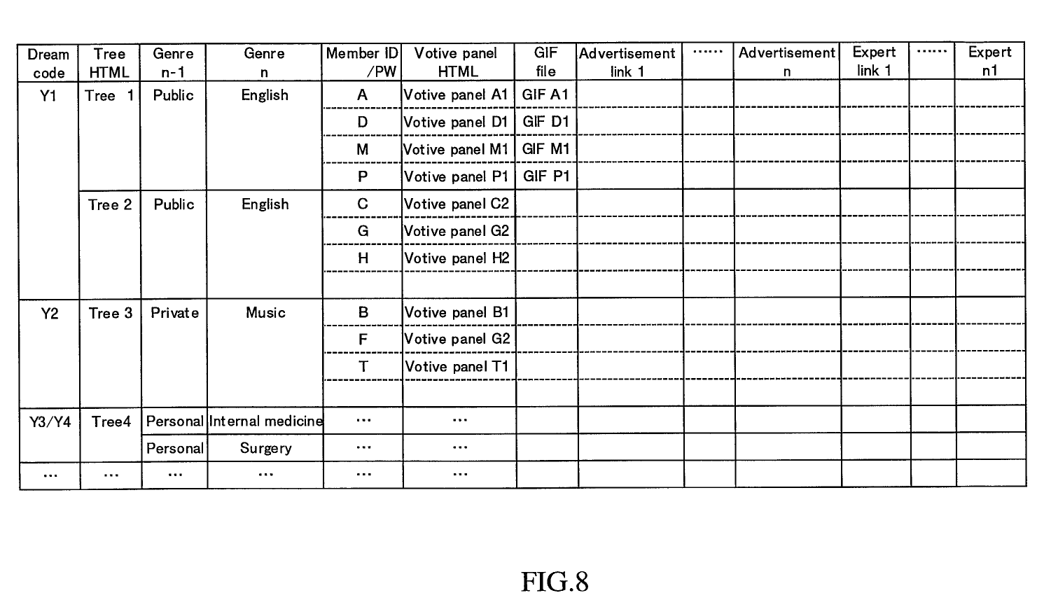

FIG. 8 is a diagram showing an example display information management table 95. In this table, information is stored that is required for the formation of a tree web page. In addition, the votive panel web page can also be formed by using the display information management table 95. This table 95 includes a dream code, a tree HTML file name (or the storage location in the storage device 9) for a tree web page, the genre name of n-th genre level and the genre name of n-1-th genre level, a member ID (a password may be included), a votive panel HTML file name (or the storage location in the storage device 9) for a votive panel web page, a GIF file name (or the storage location in the storage device 9), and information, including advertisement links, that corresponds to the genre that is specified in the link destination management table 93 for each genre. The member ID, the votive panel HTML file name, and the GIF file name are those that have been copied from the member information registration table 91.

The dream code corresponds to the genre at the lowest level, and basically, in this embodiment, a tree web page is prepared for each dream code. That is, a tree HTML file is provided for each dream code. However, as described above, the number of votive panels that can be hung from a single tree is limited, and a plurality of tree HTML files may be prepared for a single dream code. In FIG. 8, the following situation is encountered for a dream code Y1. First, it is assumed that four votive panels are hung from a single tree. Then, since the votive panels of all seven members can not be hung from a tree included in a tree HTML file whose name is tree 1, a tree is formed included in the tree HTML file name tree 2, and the votive panels of the remaining three members are hung therefrom.

For a genre (dream code) for which not many member registrations have been accomplished, preparation of a tree HTML file for each dream code is not efficient. Thus, in FIG. 8, a single tree HTML file is prepared even for different dream codes if the genre immediately above the lowest level (n-th genre level) is the same. That is, in FIG. 8, since the genres for the dream codes Y3 and Y4 (the internal medicine department and the surgical department in the genre n) differ, the dream codes Y3 and Y4 have the same genre n-1 (personal), and a tree HTML file “tree 4” is prepared for the two codes.

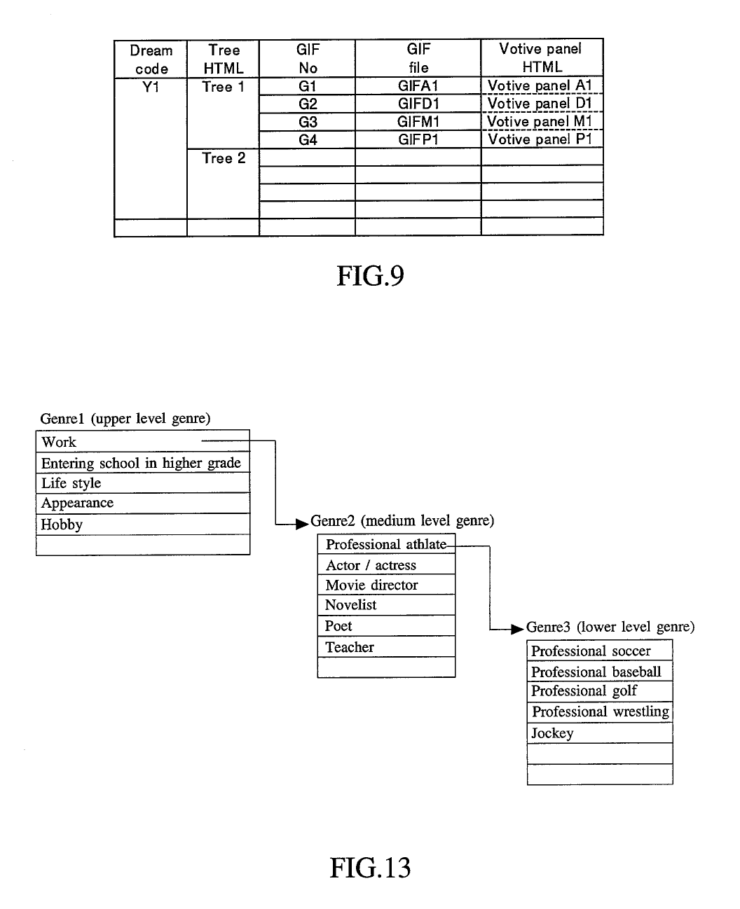

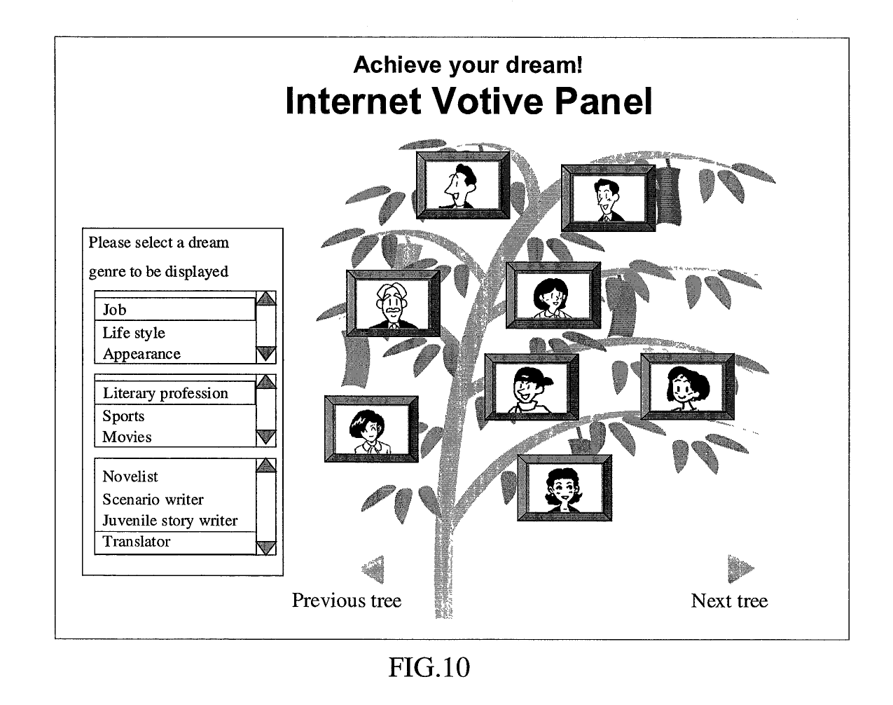

FIG. 9 is a diagram showing an example votive panel shuffle management table 97. As shown in FIG. 10, the votive panel shuffle management table 97 is employed for the shuffling of the votive panels 110 to 122 to change their locations on the tree web page in FIG. 1. The dream code, the tree HTML file name, the GIF file name and the votive panel HTML file name, all of which are registered in the display information management table 95, and a GIF number (GIF-No), which is attached to a GIF file which include a votive panel image, are stored in the votive panel shuffle management table 97. The shuffling process employed for this table will be described in detail later.

The comment storage unit 99 stores comments for each member so as to identify that a person who has registered the comment is an expert or another member. The storage device 9 also stores the GIF files, the votive panel HTML files and the tree HTML files.

An overview of the operation of the system will now be explained. A user who desires a service provided by this embodiment operates the member terminal 3 to access to the network votive panel server 7 via the network 1. Then, the display processor 71 of the network votive panel server 7 transmits display information for membership registration to the member terminal 3. The member terminal 3 receivers the display information for member registration and display it on the display device. The user completes the entry of the required data. Subsequently, the member terminal 3 transmits the data input by the user to the network votive panel server 7, along with the file containing the image information used for the votive panel, especially in this embodiment. Thereafter, the information registration unit 77 in the network votive panel server 7 registers the received information in the member information registration table 91, and transmits a membership ID and a password, via the display processor 71, to the member terminal 3, thereby completing the registration of the user as a member. That is, the user has become a member.

Then, the genre analyzer 75, based on the member information that has been newly registered in the member information registration table 91, searches the link destination management table 93 for each genre and obtains information concerning link destinations for the member. Thereafter, the member information stored in the member information registration table 91, and the obtained link destination information are registered in the display information management table 95. In addition, the genre analyzer 75 also sets the tree HTML file and the votive panels shuffle management table 97 etc.

Following this, if the member operates the member terminal 3 to log in the network votive panel server 7 by using the ID and the password, the display processor 71 employs the display information management table 95 and the votive panels shuffle management table 97 to transmit the information for the tree web page in FIG. 1 to the member terminal 3. If the member, using the member terminal 3, selects his or her votive panel or a votive panel for another member and transmits information concerning the selection to the network votive panel server 7, the display processor 71 refers to the display information management table 95 and the comment storage unit 99 to transmit the information for the votive panel web page to the member terminal 3. Then, if the member terminal 3 requests the votive panel web page for another member for the network votive panel server 7 in accordance with the member instruction, the member terminal 3 receives information from the network votive panel server 7 and displays the votive panel web page on the display device of the member terminal 3. If the member depresses the “your advice” button 246 on the votive panel web page for another member and causes the member terminal 3 to transmit information concerning the depression of the button 246, the display processor 71 transmits, to the member terminal 3, information for the comment or advice input screen shown in FIG. 3. After the member has entered his or her comment and has clicked on the registration button 252 by using the member terminal 3, the data that have been entered are transmitted to the network votive panel server 7. The comment processor 77 of the network votive panel server 7 stores the received comment in the storage area provided for the addressee member in the comment storage unit 99.

When the member operates the member terminal 3 and selects useful information or a banner advertisement included in the votive panel web page in FIG. 2, the member terminal 3 accesses to the recommended link destination server 11 or the advertiser server 13. The recommended link destination server 11 or the advertiser server 13 transmits the useful information or the contents of an advertisement to the member terminal 3. Furthermore, if the member operates the member terminal 3 and clicks on the expert homepage button 244 that is provided for the votive panel web page in FIG. 2, the member terminal 3 accesses to, for example, the expert server 15, which has prepared a homepage of an expert related to the member. Thereafter, the expert server 15 transmits information for the public homepage of the pertinent expert to the member terminal 3, and the member terminal 3 receives information for the web page and displays the public home page on the display device.

If the member operates the member terminal 3 and clicks on the expert advice request button 230 in FIG. 2, the member terminal 3 transmits information concerning the depression of the button 230 to the network votive panel server 7 and then receives information for the input screen shown in FIG. 3. Then, using the input screen, the member enters contents of an inquiry and/or a request for counseling and cause the member terminal 3 to transmit the input data to the network votive panel server 7. The comment processor 77 of the network votive panel server 7 thereafter transmits to the expert server 15, the contents of the inquiry and/or the request for counseling (including the member ID), together with the identification information for the expert related to the member. The expert server 15 receives the contents of the inquiry, and/or the request for counseling, and stores them in the storage area for a specified expert, and then transmits to the specified expert, an e-mail notifying the expert that an inquiry and/or a request for counseling has been received. The expert then employs the expert terminal 5 to access to the expert server 15, and the expert server 15 transmits to the expert terminal 5, information for an expert work homepage. The expert then enters a comment in reply to the inquiry and/or the request for counseling on the expert work homepage, and cause the expert terminal 3 to transmit the comment to the expert server 15. Subsequently, the expert server 15 transfers the comment received from the expert to the network votive panel server 7. At this time, the member who was the source of the inquiry can be identified. The comment processor 77 of the network votive panel server 7 stores the comment information into the storage unit 99, as well as information that indicates that the comment came from an expert.

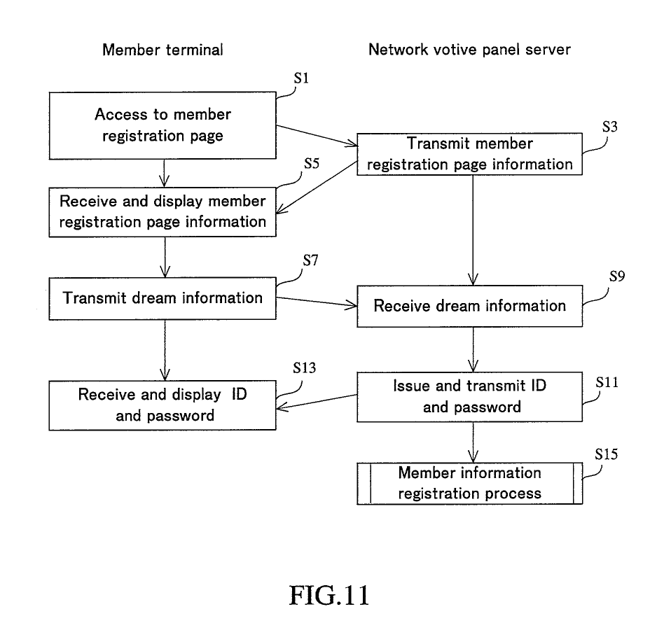

The processing performed by the system in FIG. 5 will now be described in detail while referring to FIGS. 11 to 26. FIG. 11 is a flowchart showing the processing performed for member registration. A user operates the member terminal 3 to access to the member registration page of the network votive panel server 7 (step SI). Then, the display processor 71 of the network votive panel server 7 transmits the member registration page to the member terminal 3 (step S3), as shown in the example member registration page in FIG. 12.

The member registration page in FIG. 12 includes: a name or nickname input column 260, an age input column 262, an address input column 264, a upper level dream genre (genre 1) selection box 266, a medium level dream genre (genre 2) selection box 268, a small level dream genre (genre 3) selection box 270, a column 272 for entering a comment relative to a dream, a column 274 for designating a votive panel image file, a reference button 276 for referring to files in the member terminal 3, a voice file designation column 278 for registering a voice, a reference button 280 for referring to files in the member terminal 3, a profile input column 282, and a registration button 284 for transmitting input data to the network votive panel server 7 for registration.

The dream genre is selected by a user using a table shown in FIG. 13. Choice items in the genre 1, which is an upper level genre, are stored in a table 266a. Also, the pointers to the table for the genre 2, which is the medium level genre and corresponds to each choice item included in the genre 1, are stored in the table 266a. In the upper level genre selection box 266, the choice table 266a is employed to display choice items. The pointers to the table for the genre 3, which is lower level genre and corresponds to each choice item included in the genre 2 are stored in the table 268a. In the medium level genre selection box 268, the choice table 268a is employed to display the choice items. Choice items in the genre 3, which is the lower level genre, are stored in the table 270a. In the lower level genre selection box 270, the choice table 270a is employed to display the choice items.

A desired dream genre may not be included in the choice items. To cope with this, the genre input column may be prepared. If, as in this case, a genre is added, it is possible to configure so that a user who registers next selects the added genre as well as the conventional choice items.

The votive panel image file and the voice file are transmitted to the network votive panel server 7 in accordance with, for example, the FTP (File Transfer Protocol). Further, when the reference buttons 276 and 280 are depressed, the screen for the selection of a file is displayed. The profile input column 282 in FIG. 12 is so designed that sentences can be entered in a single column; however, a column for the selection of the user attributes may also be provided.

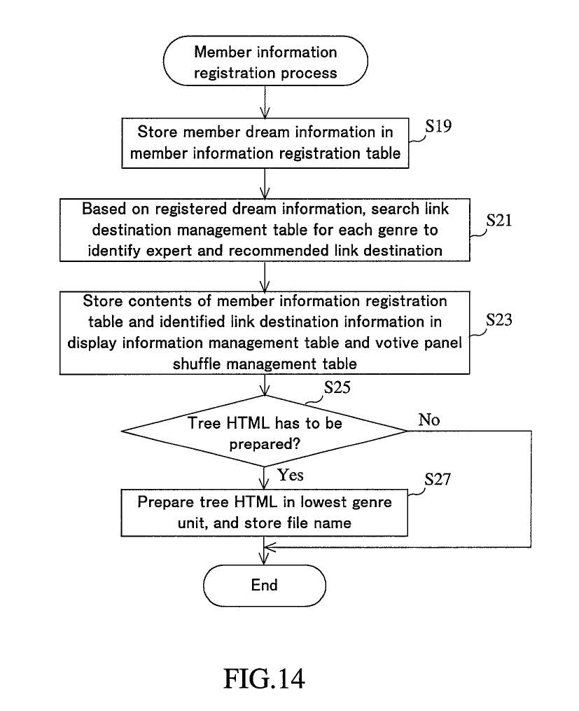

Referring again to FIG. 11, the member terminal 3 transmits dream information (including information entered on the member registration page in FIG. 12 and an image file) via the network 1 to the network votive panel server 7 (step 7). The information registration unit 73 in the network votive panel server 7 receives the dream information for the member registration (step S9), and issues a member ID and a password to the member terminal 3. Then, the information registration unit 73 transmits the member ID and a password to the terminal 3 (step 11). The member terminal 3 receives the member ID and the password, and displays them on the screen to provide notification for the user (step S13). The network votive panel server 7 performs the member information registration process (step S15). This member information registration process will now be described while referring to FIG. 14.

First, the information registration unit 73 stores the received dream information for a new member in the member information registration table 91 (step S19). Then, the genre analyzer 75 searches the link destination management table 93 for each genre, based on the registered dream information, and identifies an expert and a recommended link destination that are related to the genre registered by the pertinent member (step S21). The genre analyzer 75 stores, in the display information management table 95 and in the votive panel shuffle management table 97, contents (the member ID, the votive panel HTML file name and the GIF file name) of the member information registration table 91 and the identified link destination information (including the information concerning the expert) in accordance with a predetermined form (step S23).

The information registration unit 73 determines whether the tree HTML file should be prepared (step S25). The preparation of the tree HTML file is required if the member registers a new genre, or if the number of members exceeds the limit number of the votive panels that can be hung from one tree, and a new tree HTML file must be defined. If no need exists for the preparation of a new tree HTML file, the processing is thereafter terminated. However, if a new tree HTML file must be prepared, the information registration unit 73 prepares an tree HTML file in the lower level genre unit (=by the dream code), basically, and stores the file name (or the storage location in the storage device 9) in the display information management table 95 and the votive panel shuffle management table 97 (step S27). If there are too many members and a new tree HTML file must be prepared, an added tree HTML file is prepared for the lower level genre (the dream code). It should be noted that if a new genre is registered, only a small number of members are registered for the tree prepared in the lower level genre unit, so that a tree HTML file should be prepared in the medium level genre unit. However, if a tree HTML file is already available for the medium level genre unit, the pertinent tree HTML file should be employed. Furthermore, the dream information may not be registered at the time the member is registered. That is, the member ID and the password may be issued first, and at the next log-in time, the dream information may be registered.

Through the registration process, the tree web page and the votive panel web page, which will be described later, can be displayed by the member terminal 3.

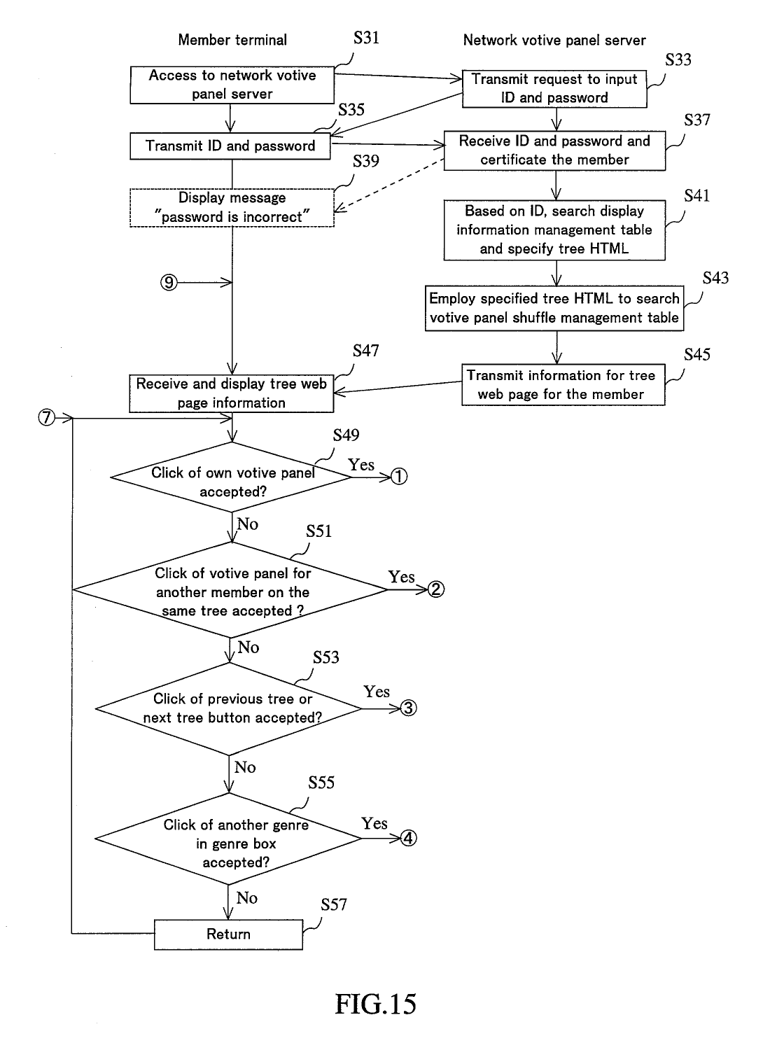

An explanation will now be given, while referring to FIG. 15, for the processing performed if the member employs the member terminal 3 to log in to the network votive panel server 7. The member operates the member terminal 3 to access to the network votive panel server 7 (step S31), and then, the display processor 71 of the network votive panel server 7 transmits, to the member terminal 3, the display information requesting the input of the member ID and the password (step S33). Thereafter, the member terminal 3 displays the display information of the input request received from the network votive panel server 7, and the member enters his or her member ID and password and causes the member terminal 3 to transmit the entered data (step S35). The display processor 71 of the network votive panel server 7 receives the member ID and the password, and performs the member certification process by referring to, for example, the member information registration table 91 (step S37). If the member ID and the password do not match those registered in the member information registration table 91, the message “password is incorrect” is transmitted to the member terminal 3. Then, the member terminal 3 displays the message (step S39).

If the member certification process is successful, the display processor 71 searches the display information management table 95, based on the member ID, and specifies the tree HTML file (step S41). The specified tree HTML file name is then employed to refer to the votive panel shuffle management table 97 (step S43). Since the tree HTML file name (or the storage location in the storage device 9) and the votive panel image file (GIF file) name (or the storage location in the storage device 9) are stored in the votive panel shuffle management table 97, the display processor 71 forms the tree web page for the member who logged in and transmits the information for the tree web page to the member terminal 3 (step S45).

The member terminal 3 receives and displays the information for the tree web page (step S47). When the tree web page is displayed, the member can select a process performed if clicking on his or her own votive panel (step S49 to a terminal 1), a process performed if clicking on the votive panel of another member on the same tree (step S51 to a terminal 2), a process performed if clicking on the “previous tree” or the “next tree” (step S53 to a terminal 3), or a process performed if clicking on another genre in the genre box (step S55 to a terminal 4). The member terminal 3 then accepts the click by the member and performs the corresponding process.

Therefore, even without entering his or her desired genre, the member can obtain the tree web page that includes a tree from which his or her votive panel is hung. That is, since the entry of a troublesome instruction is not required, a user friendly service can be provided.

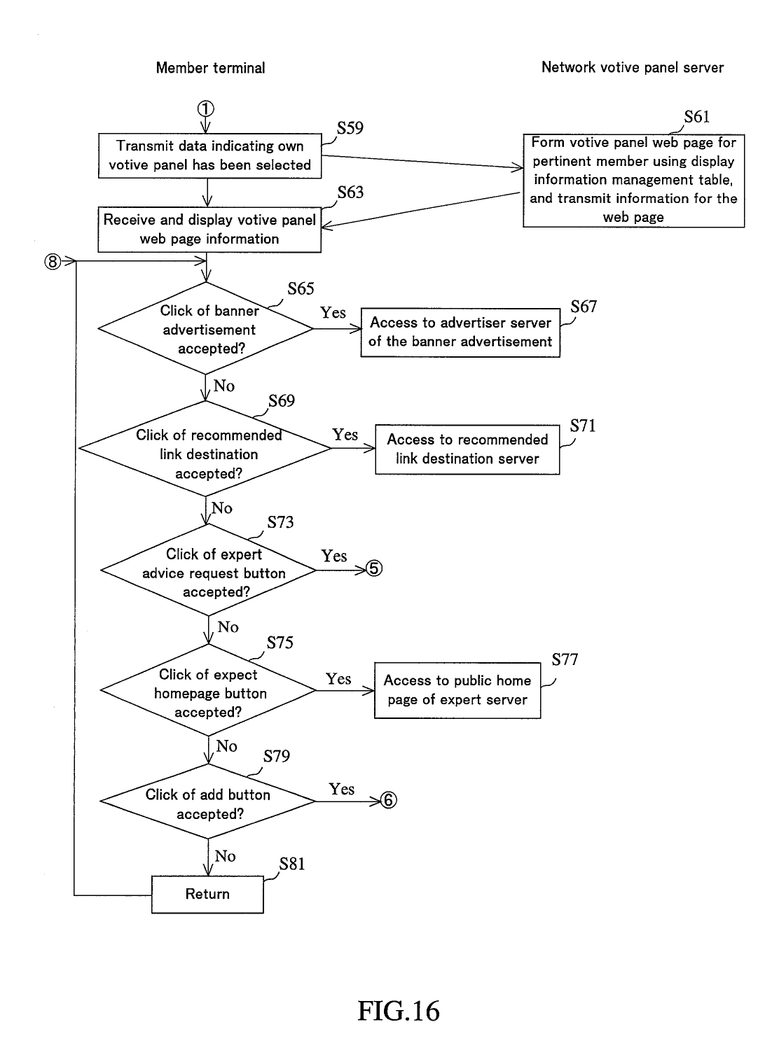

The processing (the processing following the terminal 1 in FIG. 15) performed if the member clicks on his or her votive panel will now be described while referring to FIG. 16. When the member uses a mouse to click on his or her votive panel, the member terminal 3 transmits, to the network votive panel server 7, information indicating that the member's own votive panel has been selected (step S59). The display processor 71 of the network votive panel server 7 then employs the display information management table 95 to form the votive panel web page for the pertinent member, and then transmits the information for the votive panel web page (step S61). At this time, the display processor 71 employs the votive panel HTML file, the votive panel image GIF file and the link destination information to form the votive panel web page.

The member terminal 3 receives, from the network votive panel server 7, information for the votive panel web page shown in FIG. 3, and then displays it on the display device (step S63). While the votive panel web page is being displayed, the member may click on a banner advertisement, and the member terminal 3 will accept the click of the banner advertisement (step S65) and access to the advertiser server 13 of the banner advertisement (step S67) and subsequently receive contents of the advertisement transmitted by the advertisement server 13 of the banner advertisement.

The member may also click on a recommended link destination, and the member terminal 3 will accept the click of the recommended link destination (step S69) and will access to the recommended link destination server 11 (step S71), and receive information that can usefully be employed by the member to achieve his or her dream. Thereafter, the member terminal 3 can communicate with, for example, the recommended link destination server 11. In addition, the member may also click on the expert advice request button 230. The member terminal 3 will accept the click of the expert advice request button 230 (step S73) and perform the process following the terminal 5. Furthermore, the member may also click on the expert homepage button 244. The member terminal 3 will accept the click of the expert homepage button 244 (step S75) and will access to the public homepage of the expert associated with the pertinent member in the expert server 15 (step S77). In this manner, by communicating with the expert server 15, the member terminal 3 can receive the public homepage information from the expert server 15. In addition, the member may click on the add button 226, and the member terminal 3 will accept the click of the add button 226 (step S79) and perform the process following terminal 6.

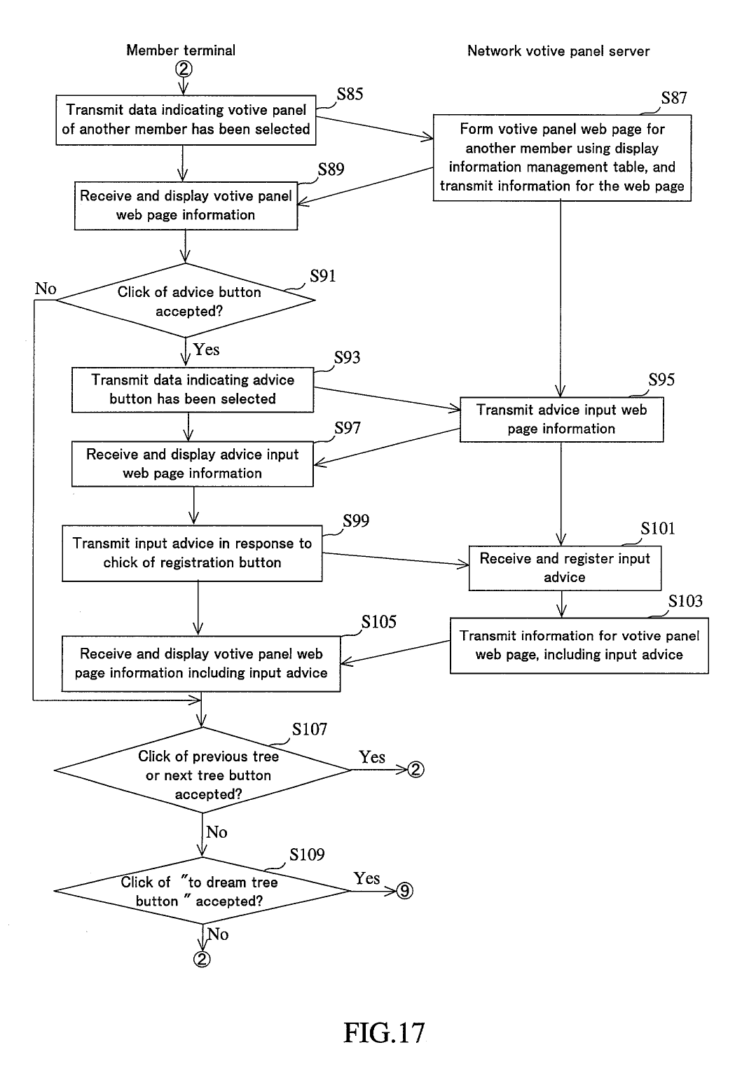

The processing (the process following the terminal 2 in FIG. 15) performed if the member clicks on the votive panel of another member will now be described while referring to FIG. 17. When the member clicks on the votive panel image of another member, the member terminal 3 transmits, to the network votive panel server 7, information indicating the votive panel of another member has been selected (step S85). The display processor 71 of the network votive panel server 7 then forms a votive panel web page for the pertinent member using the display information management table 95, and transmits information for the web page (step S87). The votive panel web page is formed in the same manner as at step S61 in FIG. 16. That is, the display processor 71 employs the votive panel HTML file, the votive panel image GIF file, and the link destination information to form the votive panel web page.

The member terminal 3 receives and displays the information for the votive panel web page for another member (step S89). When the votive panel web page for another member is displayed, the member can click on the advice button 246. The member terminal 3 then accepts the click of the advice button 246 (step S91), and transmits, to the network votive panel server 7, information indicating the advice button 246 has been selected (step S93). Then, the display processor 71 of the network votive panel server 7 transmits information for the data input web page in FIG. 3 to the member terminal 3 (step S95). The member terminal 3 receives the information from the network votive panel server 7, and displays the data input web page (step S97). Thereafter, the member enters his or her advice or comment in the input column 250 on the data input web page, and clicks on the registration button 252 to transmit the information that has been entered, such as advice. In response to the click of the registration button 252, the member terminal 3 transmits the information that has been entered, such as advice, to the network votive panel server 7 (step S99).

The comment processor 77 of the network votive panel server 7 receives the input advice information, and stores it, in the storage area for the addressee in the comment storage unit 99, as advice received from another member (step S101). The display processor 71 then refers to the comment storage unit 99 to form the votive panel web page that includes the input advice that has been registered at, for example, the head of the “advice from others” column 242 in FIG. 2, and transmits information for the votive panel web page to the member terminal 3 (step S103). Thereafter, the member terminal 3 receives the information from the network votive panel server 9 and displays the votive panel web page, including the advice (step S105).

When the votive panel web page of another member is displayed, the member may click on the “previous member” button 210 or the “next member” button 212. The member terminal 3 accepts the click of the previous member button 210 or the next member button 212 (step S107), and shifts the program control to the terminal 2, which is the head in FIG. 17. Furthermore, the member may click on the “to dream tree” button 200, and the member terminal 3 will accept the click of the “to dream tree” button 200 (step S109) and shift the program control to the terminal 9 in FIG. 15.

In this manner, the member can communicate with another member.

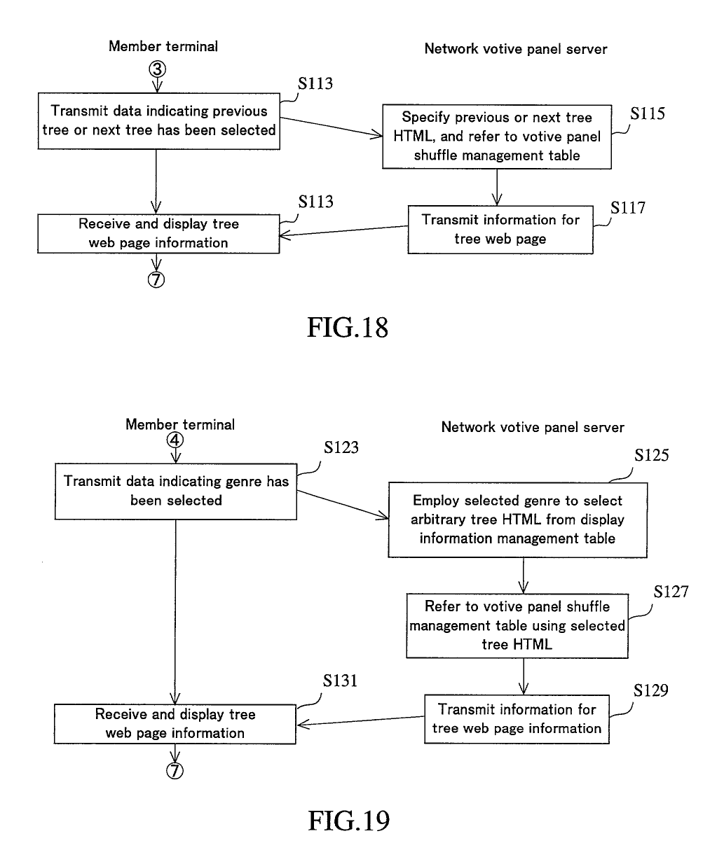

The processing (the process following the terminal 3 in FIG. 15) performed if the member clicks on the “previous tree” button 132 or the “next tree” button 134 will now be described while referring to FIG. 18. When the member uses a mouse to clicks on the “previous tree” button 132 or the “next tree” button 134, the member terminal 3 transmits, to the network votive panel server 7, information indicating the “previous tree” or “next tree” has been selected (step S113). The display processor 71 of the network votive panel server 7 then specifies the previous or the next tree HTML file in the display information management table 95, and refers to the votive panel shuffle management table 97 (step S115). The display processor 71 forms the information for the tree web page concerning the specified tree HTML file, and transmits the information to the member terminal 3 (step S117). Subsequently, the member terminal 3 receives the information from the network votive panel server 9 and displays the information for the tree web page (step S119), and thereafter, program control is shifted to the terminal 7 in FIG. 15.

The processing (the processing following the terminal 4 in FIG. 15) performed if the member clicks on a different genre in the genre box will now be described while referring to FIG. 19. When the member uses a mouse to select a different genre in the genre box, the member terminal 3 transmits, to the network votive panel server 7, information indicating the selected genre (step S123). Thereafter, the display processor 71 of the network votive panel server 7 receives the information indicating the selected genre and employs the display information management table 95 to select an arbitrary tree HTML file for the selected genre (step S125), and then, the display processor 71 employs the selected tree HTML file name to refers to the votive panel shuffle management table 97 (step S127). Subsequently, the display processor 71 forms the information for a tree web page and transmits the information to the member terminal 3 (step S129). The member terminal 3 receives the information from the network votive panel server 7 and displays the tree web page (step S131). Program control is thereafter shifted to the terminal 7 in FIG. 15.

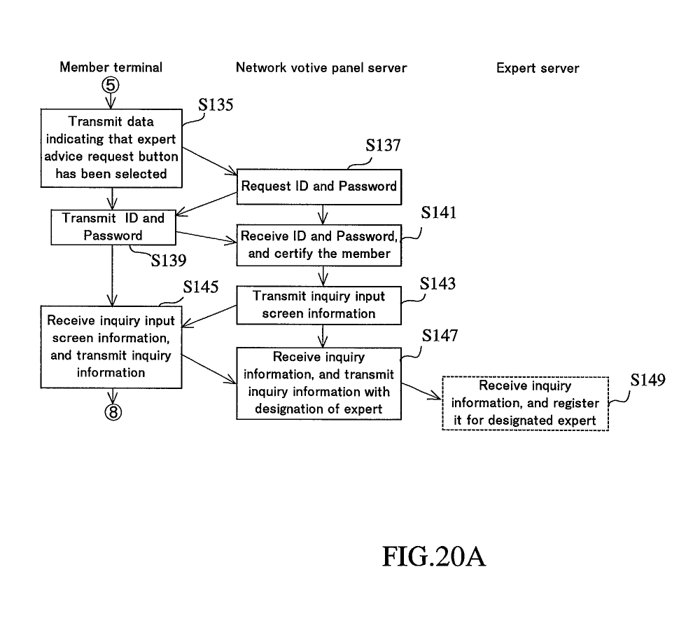

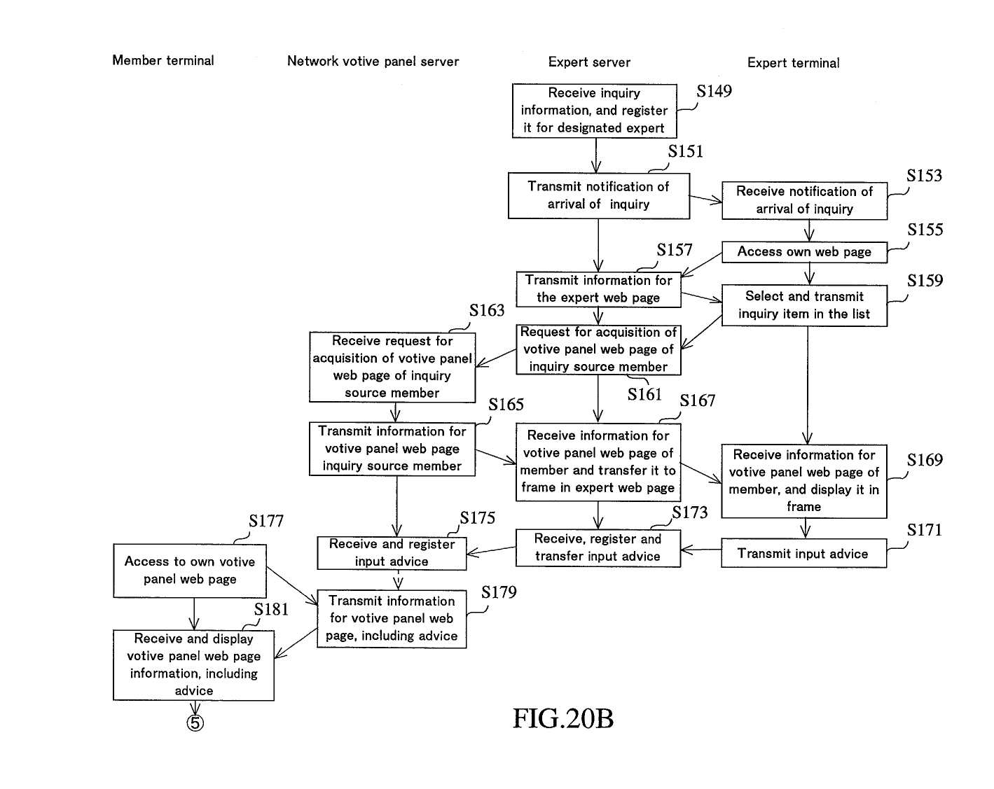

The processing (the processing following the terminal 5 in FIG. 16) performed if the member issues an inquiry or counseling request for an expert will now be described while referring to FIGS. 20A, 20B, 21 and 22. When the member uses a mouse to click on the expert advice request button 230, the member terminal 3 transmits, to the network votive panel server 7, information indicating that the expert advice request button 230 has been selected (step S135 in FIG. 20A). In response to receipt of the information indicating the selection of the expert advice request button 230, the display processor 71 of the network votive panel server 7 transmits, to the member terminal 3, display information used to request the entry of the member's ID and password (step S137). These are required because the member must personally accept the advice from the expert, and the expert's advice must be reflected on the member's votive panel web page.

Thus, the member terminal 3 receives and displays the display information used to request the entry of the member's ID and password. Then, the member enters the required information. The member terminal 3 then transmits the member's ID and password to the network votive panel server 7 (step S139). The display processor 71 of the network votive panel server 7 receives the member ID and password, and certificates them using the information stored in the member information registration table 91 (step S141). It is also possible that only the entry of the password is required. In such a case, if a member clicks on the expert advice request button 230 on the votive panel web page for another member, the advice given to the member who clicked on the expert advice request button 230 should be prevented from being registered on the votive panel web page for another member. Therefore, it may be checked whether the input password matches a password for a member ID, which corresponds to the votive panel web page in which the expert advice request button 230, which is the origin of the password entry, is provided. In any case, whether the member ID and the password are correct is determined during the member certification process. If the member ID and the password are not correct, the message “password is incorrect” is transmitted to the member terminal 3.

If the member certification processing is successful, the display processor 71 of the network votive panel server 7 transmits the information for an inquiry input screen (FIG. 3) to the member terminal 3 (step S143). The member terminal 3 receives the information and displays an inquiry input screen, and the member enters contents of an inquiry and/or request for counseling. The input information, such as an inquiry, is thereafter transmitted to the network votive panel server 7 (step S145) by the member terminal 3. The display processor 71 receives it and selects from the display information management table 95 an expert appropriate for the member. The display processor 71 then transmits to the expert server 15 the inquiry information (including the member ID) and the information identifying the expert (step S147). Thereafter, the member terminal 3 returns program control to the terminal 8 (FIG. 16).

The expert server 15 receives the inquiry information (including the member ID) and the information identifying the expert, and registers the inquiry information in the storage area for the designated expert (step S149 in FIG. 20B). The expert server 15 then transmits an e-mail to the expert, as notification that an inquiry has been received (step S151). The expert uses his or her expert terminal 5 to receive the notification that the inquiry has arrived (step S153). The expert then uses the expert terminal 5 to access to his or her web page (step S155). In response to the access by the expert terminal 5, the expert server 15 certifies the expert and transmits information for the web page for the expert to the expert terminal 5 (step S157). The web page for the expert is prepared by extracting inquiry information from the storage area allocated for the designated expert.

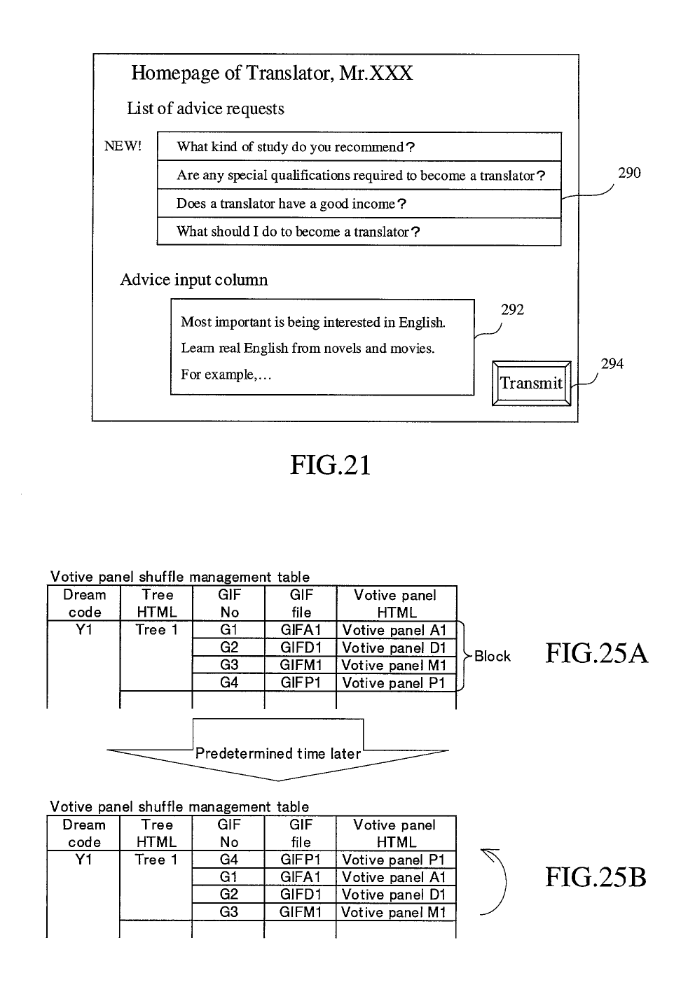

An example expert web page is shown in FIG. 21. The web page includes an inquiry list frame 290 as an advice request list, a button or link for each content, an advice input column 292, and a transmission button 294. In this embodiment, a mark “New” is added to an inquiry in the inquiry list frame 290 that has not been selected by the expert.

When the expert clicks on a specific inquiry in the inquiry list frame 290, the expert terminal 5 transmits, to the expert server 15, information indicating which inquiry has been selected (step S159). The expert server 15 identifies the ID of the member who is the source of the inquiry selected by the expert, and transmits, to the network votive panel server 7, a request for the votive panel web page of the pertinent member (step S161). The display processor 71 of the network votive panel server 7 receives the request for the votive panel web page of the member (step S163), forms the votive panel web page using data retrieved from the display information management table 95, and transmits information for the web page to the expert web server 15 (step S165). The expert server 15 receives the information for the votive panel web page for the member from the network votive panel server 7, and transmits it to the expert terminal 5 for inclusion in the frame in the expert web page (step S167).

The votive panel web page of the member may also be obtained directly from the network votive panel server 7, without the intervention of the expert server 15.

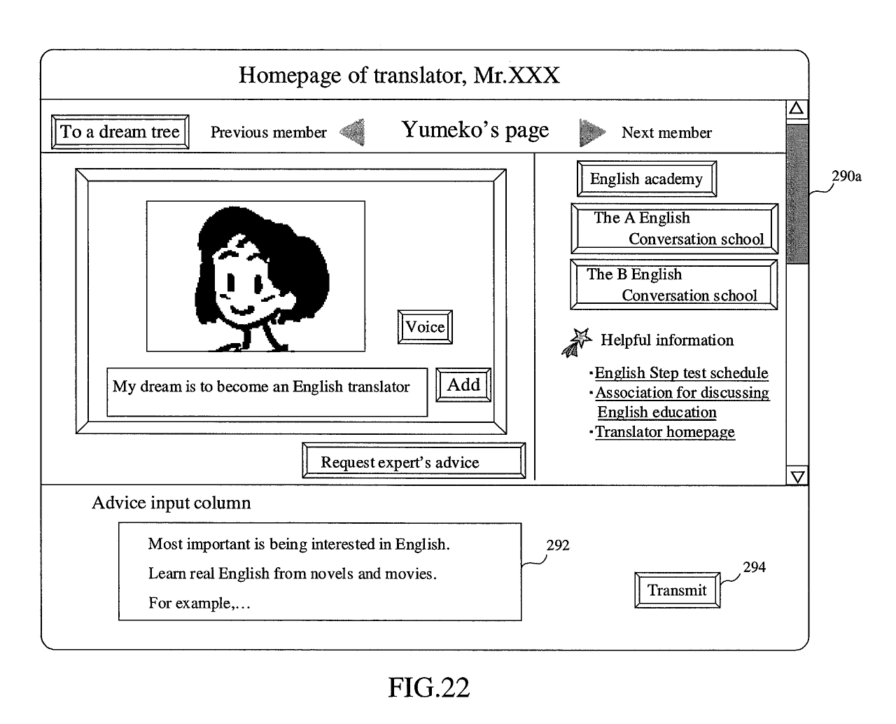

The expert terminal 5 receives the information for the member votive panel web page from the expert server 15, and displays contents of the web page in the inquiry list frame 290 (step S169). The resultant display is shown in FIG. 22. The inquiry list frame 290 is replaced by contents of the screen shown in FIG. 2, so that the expert can refer to the votive panel web page of the member while entering his or her advice in the advice input column 292. Afterwards, the expert terminal 5 transmits the input advice to the expert server 15 (step S171). The expert server 15 receives the input advice, together with the member ID, from the expert terminal 5, registers the advice and the member ID data in the storage area for the respective expert, and then transmits the two items to the network votive panel server 7 (step S173).

The comment processor 77 of the network votive panel server 7 receives, from the expert server 15, the advice provided by the expert and the member ID and registers them in the storage area allocated for the member ID in the comment storage unit 99, so that the member can ascertain that the advice was provided by the expert (step S175). The processing is thereafter temporarily terminated. Note that in consonance with the timing of an entry made by an expert, a member will not always receive requested advice in real time.

Through the processing in FIG. 15, the member then employs the member terminal 3 to access to his or her own votive panel web page (step S177). At this time, the display processor 71 of the network votive panel server 7 refers to the comment storage unit 99 and the display information management table 95 to prepare a votive panel web page that includes the advice provided for the pertinent member, and transmits information for the votive panel web page to the member terminal 3 (step S179). The member terminal 3 receives the information for the votive panel web page, including the provided advice, and displays it (step S181), so that the member can read the advice given by the expert. The member can begin actively to apply it in the pursuit of his or her dream. In this embodiment, program control thereafter returns to the terminal 8 in FIG. 16.

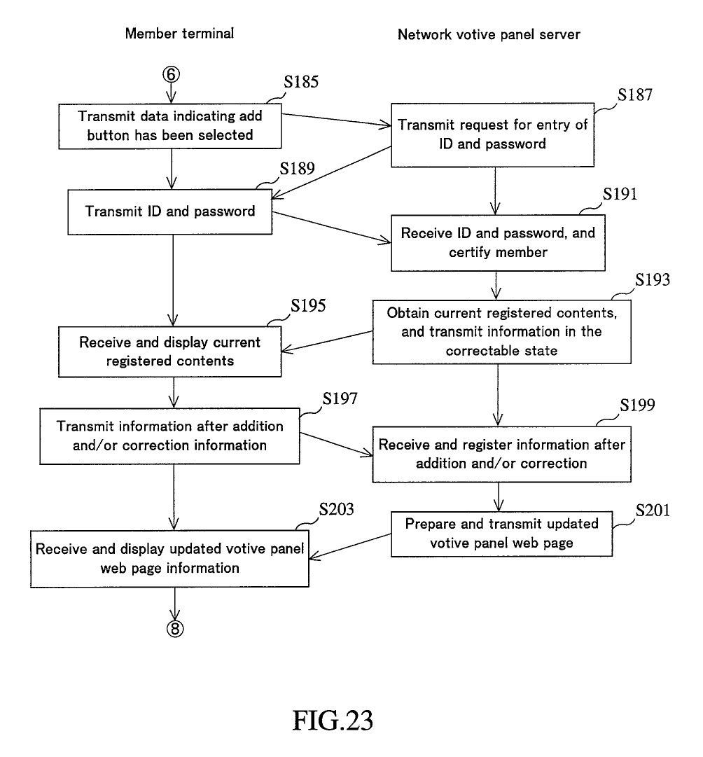

The processing (the processing following terminal 6 in FIG. 16) performed if the member clicks on the add button 226 in FIG. 2 to add information to be registered will now be described while referring to FIG. 23. When the member clicks on the add button 226 in FIG. 2, the member terminal 3 transmits, to the network votive panel server 7, information indicating that the add button 226 has been selected (step S185). In response to that, the display processor 71 of the network votive panel server 7 transmits to the member terminal 3, information for the screen requesting the input of the member ID and the password (step S187). The member terminal 3 receives the display information and displays the screen requesting the input of the member ID and the password, and the member enters his or her ID and password. Thereafter, the member terminal 3 transmits the member ID and the password to the network votive panel server 7.

The display processor 71 of the network votive panel server 7 receives the member ID and password from the member terminal 3, and certifies the member using the information stored in the member information registration table 91 (step S187). For this process, only the password may be entered, and in such a case, processing is required to determine whether the input password is the password for the member ID that corresponds to the votive panel web page which is the origin of the password input.

Thus, the information registration unit 73 of the network votive panel server 7 is used to access to the member information registration table 91 and obtains the current registered contents of the member. Then, the information registration unit 73 transmits to the member terminal 3, the display information, for example, like the screen shown in FIG. 12 in such a state that the registered contents can be corrected (step S193). For example, the contents registered in the column 272 for inputting the comment about the dream in FIG. 12 may be included in the screen in FIG. 3, for example, and information for the screen may be transmitted to the member terminal 3. The member terminal 3 receives and displays the display information wherein the current registered contents can be corrected (step S195), and the member uses the member terminal 3 to add to and/or correct the registered contents. Thereafter, the member terminal 3 transmits the information after the update (addition and/or correction) to the network votive panel server 7 (step S197).

The information registration unit 73 of the network votive panel server 7 receives the information after the update, and registers it in the member information registration table 91 (step S199). Subsequently, the display processor 71 prepares for the member a votive panel web page in which the addition and/or correction is reflected, and transmits information for the votive panel web page to the member terminal 3 (step S201). At this time, the display processor 71 simply performs a process for changing the contents of the votive panel HTML file, and the member terminal 3 receives and displays the votive panel web page information in which the addition and/or correction is reflected (step S203). Program control thereafter shifts to the terminal 8 in FIG. 16.

Through this processing, the current situation wherein the member has advanced and is one step nearer the realization of his or her dream can be registered and can be reported to other members.

The shuffling process employed to change the display in FIG. 1 so as to provide the display in FIG. 10 will now be described. The shuffling function is used to build members' interests in this service. That is, a game-playing element, in which the member searches for his or her votive panel, can be introduced to this service by changing the location of the votive panel image of each member each time he or she visits the tree web page.

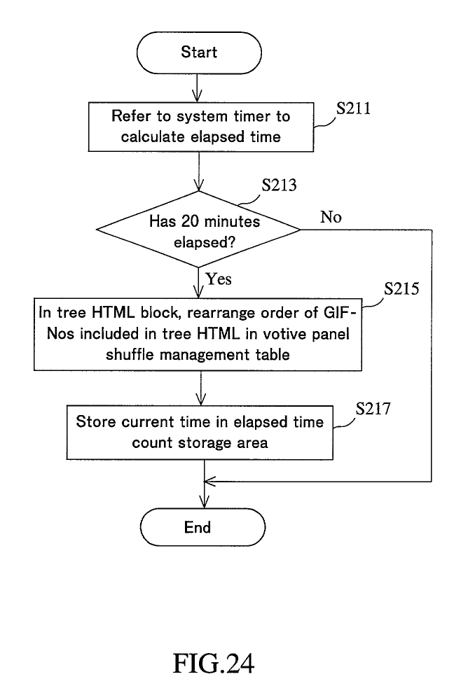

This shuffling process is performed by the display processor 71 of the network votive panel server 7. For this process, it is assumed that if a shuffle is performed, a shuffle time is stored in the elapsed time count area, and that the shuffling process in FIG. 24 will be performed at predetermined intervals. First, the system timer for the network votive panel server 7 is examined to calculate the time that has elapsed since a previous shuffle (step S211), and a check is instituted to determine whether twenty minutes has elapsed (step S213). In this case, twenty minutes is merely an example, and another period may be set. If twenty minutes have not elapsed, the processing is thereafter terminated. But if twenty minutes have elapsed, the order of the GIF-Nos that are included in the tree HTML file in the votive shuffle management table 97 are exchanged in the tree HTML block (step S215). Then, the current time is stored in the elapsed time count area (step S217).

The process at step S215 is shown in FIGS. 25A and 25B. One part of the votive panel shuffle management table 97, before it is changed, is shown in FIG. 25A. This is the same as the table shown in FIG. 9. If twenty minutes has elapsed, the process at step S215 is performed, and in the example in FIGS. 25A and 25B, the GIF-No G4 on the fourth line in the tree 1 block of the tree HTML file is moved to the first line. Accordingly, the GIF-No G1 on the first line is moved to the second line, the GIF-No G2 on the second line is moved to the third line, and the GIF-No G3 on the third line is moved to the fourth line. The resultant state is shown in FIG. 25B.

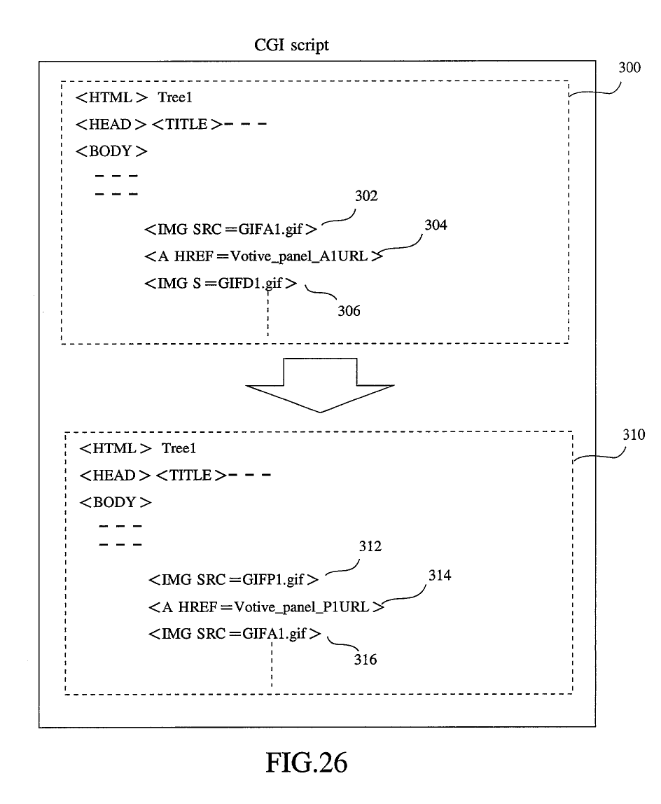

Through this processing, if the display processor 71 prepares a tree web page upon the receipt of a request from the member terminal 3, and transmits information for the tree web page to the member terminal 3, a CGI script by Perl, for example, which is included in the display processor 71, rewrites the tree HTML file wherein the votive panel image (GIF file) of the member should be included. This is specifically shown in FIG. 26. A tree HTML file 300 in FIG. 26 includes a tag 302 for reading an image file, a tag 304 for designating a link destination and a tag 306 for reading the next image file, and succeeding tags are not shown. The tree HTML file 300 is tree 1 in FIG. 25A. The GIF file name (GIFA1.gif) on the first line (GIF-No:G1) in FIG. 25A is used for the tag 302, and a votive panel Al (or the storage location in the storage device 9), which is the votive panel HTML file name on the first line in FIG. 25A, is used for the tag 304. The GIF file name (GIFD1.gif) on the second line (GIF-No:G2) in FIG. 25A is used for the tag 306.

When the votive panels in the votive panel shuffle management table 97 are shuffled, the CGI script modifies the tree HTML file 300 to provide a tree HTML file 310. The tree HTML file 310 in FIG. 26 includes a tag 312, for reading an image file, a tag 314, for designating a link destination, and a tag 316, for reading the next image file, but shows no subsequent tags. The tree HTML file 310 is a tree 1 in FIG. 25B. The GIF file name (GIFP1.gif) on the first line (GIF-No G4) in FIG. 25B is used for the tag 312, and a votive panel P1 (or the storage location in the storage device 9) that is the votive panel HTML file name on the first row in FIG. 25B is used for the tag 314. The GIF file name (GIFA1.gif) on the second line (GIF-No G1) in FIG. 25B is used for the tag 316. Using this process, the tree web page in FIG. 10 can be displayed by the member terminal 3.

The embodiment of the present invention has been explained; however, the present invention is not limited to this embodiment. The function blocks of the network votive panel server 7 constitute merely an example, and modules are not always provided in accordance with these functional blocks. Another table having the same contents as the table in this embodiment may be prepared in the storage device 9, and although the expert server 15 and the network votive panel server 7 have been separately provided, they may be conjoined. Further, the tree web page and the whole of the votive panel web page may be prepared by the CGI script, instead of the HTML file being prepared.

The above system can be implemented by installing a special program in an ordinary computer. In such a case, the program will be stored on a storage medium, such as a floppy disk, a CD-ROM or a magneto-optical disk, or in a storage device, such as a semiconductor memory or a hard disk, and the intermediate processing results will be temporarily stored in the memory.

As described above, a user can register information concerning his or her dream in a database, and can employ the information to achieve the dream. The user can also communicate with, or exchange data with, other users whose dream is representative of the same genre, and can advance together to realize their dreams. Further, the user can obtain advice from an expert or a person who has achieved his or her dream, or from a banner advertisement, related to an associated facility or a product that may assist the user in employing a specific realistic activity to implement his or her dream. Furthermore, since there is no limitation for the reference over the genre, the user can freely refer to other votive panel web pages in the different genre, and communicate with other users over the genre. Therefore, the user's world can be extended and user's consciousness can be raised.

A service provider is, for example, an Internet service provider. If memberships in which member IDs and passwords are necessary for login are adopted, an increase in sales can be expected as the number of members is increased. Further, income from banner advertisements and income from use of other services can be additionally expected.

As described above, the present invention can provide a technique for furnishing a total information service that enable a user to aggressively pursue and fulfill own object, such as a dream.

Further, the present invention also provides a technique that enables clients who share a specific object to communicate with each other.

Furthermore, a technique can be obtained for providing useful information that relates to an attribute, such as a specific object, of a client.

In addition, a technique can be provided for enabling a client to communicate with an expert concerning an attribute, such as a specific object.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A computer system comprising:
means for receiving client identification information from a terminal of one client; and
means for transmitting, to said terminal of said one client, display information wherein each of client specification information respectively specifying one client and other clients who belong to a genre registered by said one client in advance is positioned at a predetermined location, in response to receipt of said client identification information.

2. The computer system according to claim 1, wherein said client specification information is image information of a votive panel to specify a client, and wherein said display information in which said client specification information is positioned includes an image of a tree in which said image information is positioned at a predetermined location.

3. The computer system according to claim 1, wherein said client specification information is grouped for each predetermined number of member s who belong to the same genre, and wherein said display information include s information for instructing to acquire display information that includes said client specification information related to another group in said genre registered by said one client.

4. The computer system according to claim 1, further comprising:
means for, if information indicating selection of client specification information is received from said terminal of said one customer, reading out, from a data storage device, information that matches an attribute registered in advance for a client that corresponds to the selected client specification information, and for forming display information for said client by using the read information; and
means for transmitting, to said terminal of said one client, said formed display information.

5. The computer system according to claim 4, wherein said information that matches said attribute registered in advance for the client includes at the least either an advertisement, or reference destination information for information associated with said attribute.

6. The computer system according to claim 4, further comprising:
means for registering a comment for a client, said comment received from a different client,
wherein said means for reading out includes the registered comment from said different client into said display information for the client.

7. The computer system according to claim 4, further comprising:
means for requesting a comment for an expert in a genre registered in advance by said one client,
wherein said means for reading out includes said comment received from said expert into said display information for said one client.

8. The computer system according to claim 7, further comprising:
means for, if a request for said comment by said expert is received from said terminal of said one client, transmitting said request to said expert;
means for, upon receipt of a request from an expert terminal, transmitting said display information for said one client to said expert terminal; and
means for, upon receipt of comment information from said expert terminal, storing said comment information in a storage area for said one client.

9. The computer system according to claim 4, wherein said display information for the client includes reference destination information to public information of an expert in the genre registered in advance by the client.

10. The computer system according to claim 9, wherein said public information includes information concerning a comment request submitted by the client.

11. The computer system according to claim 1, wherein said means for transmitting display information changes said location of said client specification information at a predetermined time intervals, and transmits the changed display information upon receipt of a request from said terminal of said one client.

12. The computer system according to claim 1, wherein said means for transmitting display information comprises: means for reading out, from a data storage device, client specification information wherein said client specification information respectively specifies one client and other clients who belong a genre registered by said one client; and means for transmitting, to said terminal of said one client, display information including the read client specification information and a template used to display said client specification information at a predetermined location.

13. The computer system according to claim 2, wherein said image of said tree is changed as time elapses.

14. The computer system according to claim 1, wherein said genre is defined for a dream of a client, and wherein, if a client specifies a genre other than those that are prepared in advance at the client registration, said genre specified by the client is added to available choice items for a next registration.

15. A storage medium for storing a program, said program comprising the steps of:
receiving client identification information from a terminal of one client; and
in response to receipt of said client identification information, transmitting, to said terminal of said one client, display information wherein each of client specification information respectively specifying one client and other clients who belong to a genre registered by said one client in advance is positioned at a predetermined location.

16. The storage medium according to claim 15, wherein said program further comprises the steps of:
if information indicating selection of client specification information is received from said terminal of said one customer, reading out, from a data storage device, information that matches an attribute registered in advance for a client that corresponds to the selected client specification information, and for forming display information for said client by using the read information; and
transmitting, to said terminal of said one client, said formed display information.

17. The storage medium according to claim 16, wherein said program further comprises a step of registering a comment for a client, said comment received from a different client, and
wherein said step of reading out comprises a step of including the registered comment from said different client into said display information for the client.

18. The storage medium according to claim 16, wherein said program further comprises a step of requesting a comment for an expert in a genre registered in advance by said one client, and
wherein said step of reading out comprises a step of including said comment received from said expert into said display information for said one client.

19. The storage medium according to claim 18, wherein said program further comprises the steps of:
if a request for said comment by said expert is received from said terminal of said one client, transmitting said request to said expert;
upon receipt of a request from an expert terminal, transmitting said display information for said one client to said expert terminal; and
upon receipt of comment information from said expert terminal, storing said comment information in a storage area for said one client.

20. The storage medium according to claim 15, wherein said step of transmitting display information comprises the steps of:
changing said location of said client specification information at a predetermined time intervals; and
transmitting the changed display information upon receipt of a request from said terminal of said one client.

21. The storage medium according to claim 15, wherein said step of transmitting display information comprises the steps of:
reading out, from a data storage device, client specification information wherein said client specification information respectively specifies one client and other clients who belong a genre registered by said one client; and
transmitting, to said terminal of said one client, display information including the read client specification information and a template used to display said client specification information at a predetermined location.

22. An information providing method comprising the steps of:
receiving client identification information from a terminal of one client; and
in response to receipt of said client identification information, transmitting, to said terminal of said one client, display information wherein each of client specification information respectively specifying one client and other clients who belong to a genre registered by said one client in advance is positioned at a predetermined location.

23. The information providing method according to claim 22, further comprising the steps of:
if information indicating selection of client specification information is received from said terminal of said one customer, reading out, from a data storage device, information that matches an attribute registered in advance for a client that corresponds to the selected client specification information, and for forming display information for said client by using the read information; and
transmitting, to said terminal of said one client, said formed display information.

24. The information providing method according to claim 23, further comprising a step of registering a comment for a client, said comment received from a different client, and
wherein said step of reading out comprises a step of including the registered comment from said different client into said display information for the client.

25. The information providing method according to claim 23, further comprising a step of requesting a comment for an expert in a genre registered in advance by said one client, and
wherein said step of reading out comprises a step of including said comment received from said expert into said display information for said one client.

26. The information providing method according to claim 25, further comprising the steps of:
if a request for said comment by said expert is received from said terminal of said one client, transmitting said request to said expert;
upon receipt of a request from an expert terminal, transmitting said display information for said one client to said expert terminal; and
upon receipt of comment information from said expert terminal, storing said comment information in a storage area for said one client.

27. The information providing method according to claim 22, wherein said step of transmitting display information comprises the steps of:
changing said location of said client specification information at a predetermined time intervals; and
transmitting the changed display information upon receipt of a request from said terminal of said one client.

28. The information providing method according to claim 22, wherein said step of transmitting display information comprises the steps of:
reading out, from a data storage device, client specification information wherein said client specification information respectively specifies one client and other clients who belong a genre registered by said one client; and
transmitting, to said terminal of said one client, display information including the read client specification information and a template used to display said client specification information at a predetermined location.

29. The information providing method according to claim 22, wherein said display information in which said client specification information is positioned includes an image of a tree in which said image information is positioned at a predetermined location, and wherein said method further comprises a step of changing said image of said tree as time elapses.

30. An information acquisition method comprising the steps of:
transmitting client identification information to an information providing server;
receiving, from said information providing server, display information wherein each of client specification information respectively specifying one client and other clients who belong to a genre registered by said one client in advance is positioned at a predetermined location; and
displaying said display information on a display device.

31. The information acquisition method according to claim 30, further comprising the steps of:
transmitting information indicating selection of client specification information to said information providing server;
receiving, from said information providing server, display information for the client that corresponds to the selected client specification information, wherein said display information for the client includes information that matches an attribute registered in advance for said client; and
displaying the received display information for the client.
